(19) United States
(12) Patent Application Publication
(10) Pub. No.: US 2021/0400390 A1
(43) Pub. Date: Dec. 23, 2021

(54) REINFORCING PART FOR DIAPHRAGM OF SPEAKER, THE DIAPHRAGM AND THE SPEAKER

(71) Applicant: Goertek lnc., Weifang, Shandong (CN)

(72) Inventors: Yong Li, Shandong (CN); Cuili Zhang, Shandong (CN)

(73) Assignee: Goertek lnc., Weifang, Shandong (CN)

(21) Appl. No.: 17/292,513

(22) PCT Filed: Dec. 20, 2018
(86) PCT No.: PCT/CN2018/122339

§ 371 Date: May 10, 2021

(30) Foreign Application Priority Data
Nov. 9, 2018 (CN) 201811331624.6

(51) Int. Cl. H04R 7/04

(52) U.S. Cl. CPC H04R 7/04; H04R 2400/13

(57) ABSTRACT

Disclosed is a reinforcing part for a speaker diaphragm. The reinforcing part includes a body layer, and the body layer includes through-holes penetrating surfaces of two sides of the body layer. The reinforcing part further includes fillers located within the through holes and configured for heat conduction. The fillers have a thermal conductivity higher than that of the body layer. The reinforcing part of the present invention improves the heat conduction capability between two sides of a support layer by providing through holes on the support layer and providing a heat-conducting filler within the through holes.

### CROSS-REFERENCE TO RELATED APPLICATIONS

This application is a National Stage of International Application No. PCT/CN2018/122339, filed on Dec. 20, 2018, which claims priority to Chinese Patent Application No. 201811331624.6, filed on Nov. 9, 2018, both of which are hereby incorporated by reference in their entireties.

### TECHNICAL FIELD

The present disclosure relates to the field of electro-acoustic technology. More specifically, it relates to a reinforcing part structure for a diaphragm of a speaker, as well as the diaphragm and the speaker to which the reinforcing part structure is applied.

### BACKGROUND

A speaker, as a component which can convert electrical energy into sound, is widely used in electronic terminal devices such as mobile phones, tablet computers, notebooks, PDAs. A speaker structure typically includes a magnetic circuit system, a vibration system and an auxiliary system, wherein the vibration system essentially includes a diaphragm and a voice coil. When the speaker is in operation, the voice coil generates a lot of heat which cannot be easily dissipated to the outside, since the voice coil is located in a rear acoustic cavity of the speaker which is relatively closed.

Since a front acoustic cavity of the speaker is in communication with the outside through sound holes, a prior art speaker is typically provided with a reinforcing part (a DOME, also called an overlapping part) on the diaphragm, in order to enhance the performance of the high-frequency position of the product. Therefore, through the reinforcing part structure, the heat generated by the voice coil may be conducted from the rear acoustic cavity to the front acoustic cavity, and in turn the heat is dissipated to the outside through the air flow between the front acoustic cavity and the outside, thereby realizing heat dissipation from the speaker.

A prior art reinforcing part structure is typically made of a resin composite material, a metal material, or a composite material of metal and resin; however, such a reinforcing part structure has a low thermal conductivity and a poor heat conduction performance, and thus cannot meet the heat dissipation requirements of a micro speaker. Therefore, there is a need to provide a new reinforcing part structure with an excellent performance of heat conduction.

### SUMMARY

An objective of the present invention is to provide a reinforcing part structure with a high thermal conductivity.

According to an aspect of the invention, a reinforcing part is provided, which includes a body layer, and the body layer includes through-holes penetrating surfaces of two sides of the body layer, and the reinforcing part further includes fillers located within the through holes and configured for heat-conduction.

Preferably, the fillers have a thermal conductivity higher than that of the body layer.

Preferably, sidewall surfaces of the fillers are bonded and fixed to inner walls of the through holes by adhering.

Preferably, side wall surfaces of the fillers are fitted and fixed to inner walls of the through holes by interference fit.

Preferably, the body layer includes a plurality of through holes penetrating surfaces of two sides of the body layer, wherein the plurality of through holes are evenly distributed on the body layer.

Preferably, the through hole has a cross-sectional shape that is circular, elliptical or rectangular.

Preferably, the body layer is made of carbon fiber, resin or steel.

Preferably, the fillers are a heat-conducting particles; wherein the fillers are made of graphene, copper or aluminum.

According to another aspect of the invention, a diaphragm is provided, and the diaphragm includes a fixing part, a corrugated rim integral with the fixing part, a central part located within the corrugated rim, and the above-mentioned reinforcing part bonded and fixed to a surface of the central part.

According to yet another aspect of the inventions, a speaker is provided, and the speaker includes the above-mentioned diaphragm.

The beneficial effects provided by the present invention are as follows:

The reinforcing part of the present invention improves the heat conduction capability between two sides of a support layer by providing through holes on the support layer and providing a heat-conducting filler within the through holes. In a speaker adopting such a reinforcing part structure, heat may be quickly conducted from a rear acoustic cavity to a front acoustic cavity, and may be dissipated outward through the air flow between the front acoustic cavity and the outside, thereby realizing quick heat dissipation from the speaker.

### BRIEF DESCRIPTION OF THE DRAWINGS

The specific embodiments of the present invention will be described below in further detail with reference to the accompanying drawings.

FIG. 1 shows a schematic, exploded structural diagram of the reinforcing part according to the present invention.

FIG. 2 shows a schematic, exploded structural diagram of the diaphragm according to the present invention.

FIG. 3 shows a schematic, exploded structural diagram of a vibration system of the speaker according to the present invention.

### DETAILED DESCRIPTION

To explain the present invention more clearly, the present invention will be further described below with reference to preferred embodiments and the accompanying drawings. Similar parts are represented by the same reference numerals in the drawings. Those skilled in the art should understand that the following detailed embodiments are illustrative rather than restrictive, and should not be interpreted as limitation to the protection scope of the present invention.

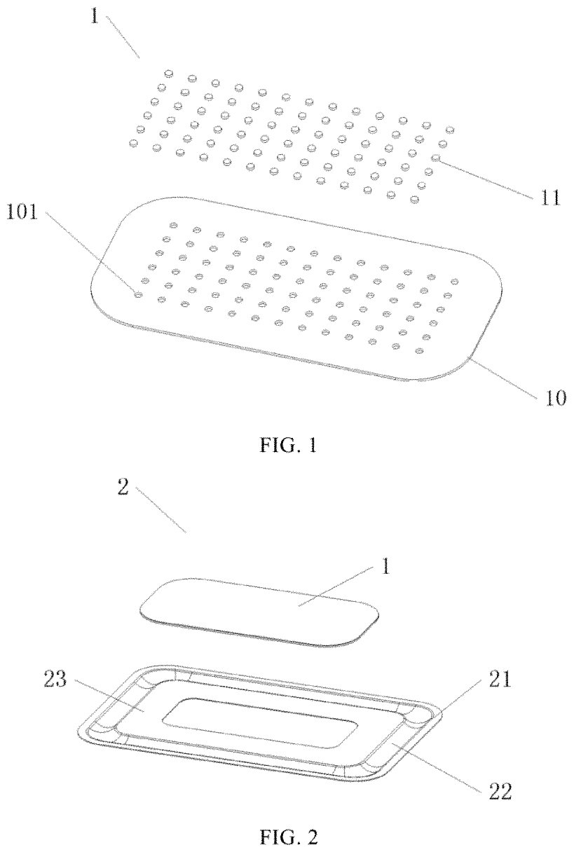

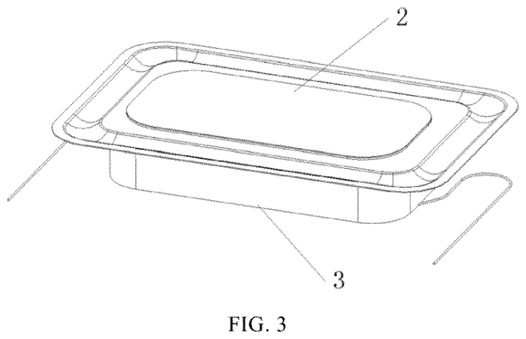

As shown in FIG. 1, the present invention provides a reinforcing part 1 for a diaphragm, wherein the shape of the reinforcing part 1 is not limited and depends on practical application, such as circular, rectangular, elliptical, etc.; the reinforcing part 1 is made into the shape of a plate, a sphere, etc. according to practical needs, and is overlapped on the diaphragm for direct use. The reinforcing part 1 includes a body layer. The body layer 10 is made of a material selected from one of metal material, resin material or carbon fiber material, and may be a thin plate through a corresponding process selected according to the respectively selected material of the body layer 10.

In order to improve heat transfer efficiency between the two sides of the body layer 10, the body layer 10 of the present invention includes: through holes 101 penetrating the surfaces of the two sides, and fillers 11 arranged in the through holes 101 and having a thermal conductivity greater than that of the body layer 10. Such structure can improve the heat conduction between the two sides of the body layer 10, thereby improving the overall heat conduction capability of the reinforcing part.

Further, the fillers 11 may be made of a material selected from one of graphene, copper or aluminum, and are heat-conducting particles. In this embodiment, the fillers 11 are a copper particles located in the through holes 101 of a steel sheet.

The outer surfaces of the fillers 11 and the inner walls of the through holes 101 are fitted onto each other. Preferably, the above two are fixedly connected by adhering or are fitted and fixed by interference fit. Such structure enhances the connection strength between the fillers 11 and the body layer 10, thereby improving the reliability of the reinforcing part 1.

In another embodiment, the fillers 11 are in a powder form. In order to increase the connection strength between the powdered fillers 11 and the through holes 101, the fillers 11 may be mixed with adhesive therein such that the fillers 11 are fixedly connected to the through holes 101.

Further, the body layer 10 includes a plurality of through holes 101 penetrating through the surfaces of the two sides, which are evenly distributed on the both layer 10 and each of which is provided with a filler 11, so as to further improve the heat conduction capability between the two sides of the body layer 10.

The cross-sectional shape of the through holes 101 provided on the body layer 10 may be a circle, an ellipse or a rectangle, and may be selected by those skilled in the art according to the practical need.

As shown in FIG. 2, the invention further provides a diaphragm 2. The diaphragm 2 includes a fixing part 21 fixed to a sound generator housing, a corrugated rim 22 integral with the fixing part 21, a central part 23 located within the corrugated rim 22, and a reinforcing part 1 bonded and fixed to the central part 23. The central part 23 is a hollowed-out structure, and the reinforcing part 1 is fixedly bonded to the hollowed-out part. Due to the aforementioned structure of the reinforcing part 1, there is high heat conduction capability between the two sides of the body layer 10, thereby improving the heat conduction capability between the two sides of the diaphragm.

The present invention also provides a speaker. The speaker includes a magnetic circuit system and a vibration system in cooperation with the magnetic circuit system. The vibration system includes the above-mentioned diaphragm 2 and a voice coil 3 fixedly bonded to one side of the diaphragm 2. In the speaker of the present invention, the heat generated by the voice coil 3 is conducted from the rear acoustic cavity to the front acoustic cavity through the diaphragm 2, and in turn is dissipated to the outside through the air flow between the front acoustic cavity and the outside. Since the diaphragm 2 has strong heat conduction capability and may quickly dissipate the heat from the speaker, as such, the speaker of the present invention has good heat dissipation capability and thereby improved operation reliability.

Obviously, the above-mentioned embodiments of the present invention are merely examples for clear illustration of the present invention, and are not meant to limit the implementation of the present invention. For those of ordinary skill in the art, other changes or modifications may be made in various manners based on the foregoing description. Although it is not possible to list all the implementations here, any obvious changes or modifications derived from the technical solutions of the present invention still fall within the protection scope of the present invention.

1. A reinforcing part for a speaker diaphragm, comprising a body layer, wherein the body layer comprises a plurality of through-holes penetrating surfaces of two sides of the body layer, and the reinforcing part further comprises a plurality of fillers, each located within one of the through holes and configured for heat-conduction.

2. The reinforcing part for a speaker diaphragm of claim 1, wherein the plurality of fillers have a thermal conductivity higher than that of the body layer.

3. The reinforcing part for a speaker diaphragm of claim 1, wherein each of the plurality of fillers have a sidewall surface bonded and fixed to an inner wall of one of the plurality of through holes by adhering.

4. The reinforcing part for a speaker diaphragm of claim 1, wherein each of the plurality of fillers have a sidewall surface fitted and fixed to an inner wall of one of the plurality of through holes by an interference fit.

5. The reinforcing part for a speaker diaphragm of claim 1, wherein the body layer comprises a plurality of through holes penetrating surfaces of two sides of the body layer, wherein the plurality of through holes are evenly distributed on the body layer.

6. The reinforcing part for a speaker diaphragm of claim 1, wherein each of the plurality of through holes has a cross-sectional shape that is circular, elliptical or rectangular.

7. The reinforcing part for a speaker diaphragm of claim 1, wherein the body layer is made of carbon fiber, resin or steel.

8. The reinforcing part for a speaker diaphragm of claim 1, wherein the plurality of fillers are heat-conducting particles made of graphene, copper or aluminum.

9. A diaphragm, comprising a fixing part, a corrugated rim integral with the fixing part, a central part located within the corrugated rim, and the reinforcing part for a speaker diaphragm of claim 1, the reinforcing part being bonded and fixed to a surface of the central part.

10. A speaker, comprising the diaphragm of claim 9.
